(19) United States
(12) Patent Application Publication
(10) Pub. No.: US 2006/0157631 A1
(43) Pub. Date: Jul. 20, 2006

(54) Post support

(76) Inventors: Clay Christopher Cunningham, Stoney Plain (CA); Bradley Edwin Balzer, Carvel (CA); Glenn George Fehsl, Stoney Plain (CA)

Correspondence Address: ANTONY C. EDWARDS, SUITE 200 - 270 HIGHWAY 33 WEST, KELOWNA, BC, V1X 1X7, CA

(21) Appl. No.: 11/034,756

(22) Filed: Jan. 14, 2005

(51) Int. Cl. F16M 13/00

(52) U.S. Cl. 248/545; 52/298

(57) ABSTRACT

A post support installed below ground level to anchor a post is provided. The post support includes a receiving member configured to receive a post wherein the receiving member is installed below ground level such that the receiving member is substantially disposed underground. A collar defining an aperture is detachably mounted to the receiving member such that the post journals through the aperture. A first securing means detachably secures the post to the receiving member and a second securing means detachably secures the collar to the receiving member. The collar, the first securing means and the second securing means cooperate to deter and prevent unauthorized removal of the post from the receiving member.

### FIELD OF THE INVENTION

The present invention relates generally to a ground support for a post.

### BACKGROUND OF THE INVENTION

Posts and poles and other similar upright supports structures that for example may display a sign, such as a road sign or support a fence, etc, are typically installed in the ground by digging a hole inserting the post into the hole, and stabilizing the post in the hole by using concrete, or backfill, or stones or the like. A post support or anchor such as described in the prior art set out below may be permanently installed in the ground to protect the base of the post from elemental damage and to assist in maintaining the upright position of the post. It may also be desirable to install a post support in the ground such that the post may be easily inserted and removed for replacement without expending a lot of manual labour.

There are several devices and apparatus known in the art designed to support a post. For example, U.S. Pat. No. 5,082,231 to Knowles, issued Jan. 21, 1992 provides a post support for permanent installation at or below ground level wherein fins secured to a collar are driven into the ground such that the upper edge of the collar is level with the surface of the ground. A post may be inserted into the collar wherein the length of the collar is chosen so as to support the post without substantial wiggling. In addition, U.S. Pat. No. 5,165,663 to Wells, issued Nov. 24, 1992 describes a ground anchor for a post wherein a vertically extending cylindrical PVC tube having a conical end member may be driven into the ground. A post may be inserted into and removed from the tube. At the upper end of the tube, a collar having a central opening and a flange portion is provided wherein the flange portion engages the ground to prevent grass from growing around the tube. Furthermore, U.S. Patent Application Publication No. 2004/0169121 to Winn, published Sep. 2, 2004 provides a flag pole anchor wherein a cylindrical shaft having an opening at an upper end receives a flag pole, the cylindrical shaft insertable in a hole drilled in a headstone or in the concrete surrounding a monument. An annular collar encircles the opening.

While the prior art provides devices to support and/or anchor a post such that the post may be maintained in a vertical position, none of the prior art devices teach nor suggest a support that provides the advantages of the present invention. For example, none of the devices provide a securing means to prevent impermissible withdrawal of the post from the support. By further example, prior art devices are designed to be driven into the ground and fail to provide a support that may be installed in other types of terrain such as asphalt.

### SUMMARY OF THE INVENTION

It is therefore an object of the present invention to provide a post support that may be installed in concrete, asphalt, earth, or other terrain, substantially below ground level such that a lower portion of a post may be insertable in the post support to anchor the post to the ground, and wherein the post support includes a means to inhibit unauthorized withdrawal of the post from the post support.

In accordance with the present invention there is provided a post support having a hollow post-receiving member configured to snugly receive a post wherein the post-receiving member may be installed below ground level such that the post-receiving member is substantially disposed underground. In one embodiment a collar defining an aperture is detachably mounted to an open end of the post-receiving member such that the post journals through the aperture and into the hollow post-receiving member. A first securing means detachably secures the post in the post-receiving member. The first securing is mounted under the collar and cooperates to retain the post in the receiving member.

In an embodiment of the invention, the receiving member may be an elongate vertically extending sleeve having an open end and a closed end, the sleeve defining a central bore configured to snugly and securely receive the post. The receiving member forms a rim around the open end of the sleeve such that the rim defines the open end wherein the post may be removably inserted into the central bore. The rim engages the surface above ground level. The first securing means detachably secures the rim to the post when the post is inserted into the receiving member such that the first securing means may be accessible from above ground level so that the first securing means may be detached to withdraw the post from the receiving member.

A second securing means detachably secures the collar to the rim. The second securing means is accessible from above ground level such that the collar may be removed so that, with the collar removed, the first securing means may be detached to withdraw the post from the receiving member. The collar may be annular having a flange extending horizontally and radially outwards such that the flange engages the surface above ground level. Advantageously the flange is relatively large to both control the growth of weeds, grass etc close to the post and to inhibit ease of access under the collar so as to inhibit access to the first security means. The flange may further function to prevent ingress of fluid into the receiving member to prevent damage to the post. The flange secured to the rim prevents access to the first securing means such that unauthorized withdrawal of the post from the receiving member may be deterred. In an embodiment of the invention, the first and the second securing means may include a security feature to prevent unauthorized removal of the first and the second securing means.

The receiving member and the collar may be made of a synthetic material capable of protecting the post from environmental damage such that the structural integrity of the post may be preserved. Preferably, the receiving member is substantially rectangular and extends between two and eight feet in length below ground level when installed.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side perspective view of the post support according to the present invention;

FIG. 2 is a side perspective view of the post support of FIG. 1 installed in the ground;

FIG. 3 is a side perspective view of a post disposed within the post receiving member of the post support of FIG. 2;

FIG. 4 is a side perspective view of a post secured by the post support of FIG. 2; and

FIG. 5 is a front view of a broken post being withdrawn from the receiving member of the post support of FIG. 2 for ease of replacement.

FIG. 6, 6a and 6b are exploded perspective views of the post support of FIG. 1.

FIG. 6c is an enlarged view of an alternative embodiment of the second securing means.

FIG. 6d is a side perspective view of an alternative embodiment of the post receiving member of the post support.

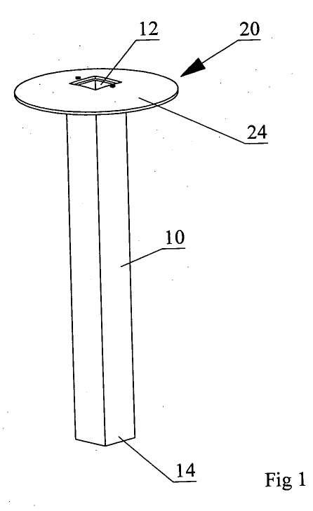

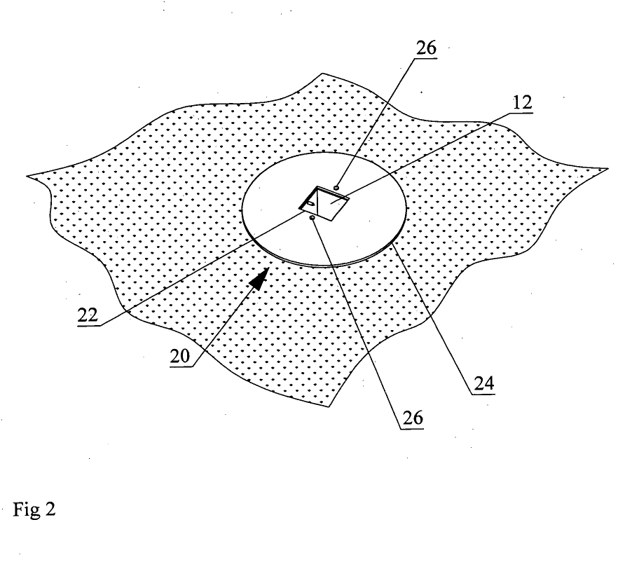

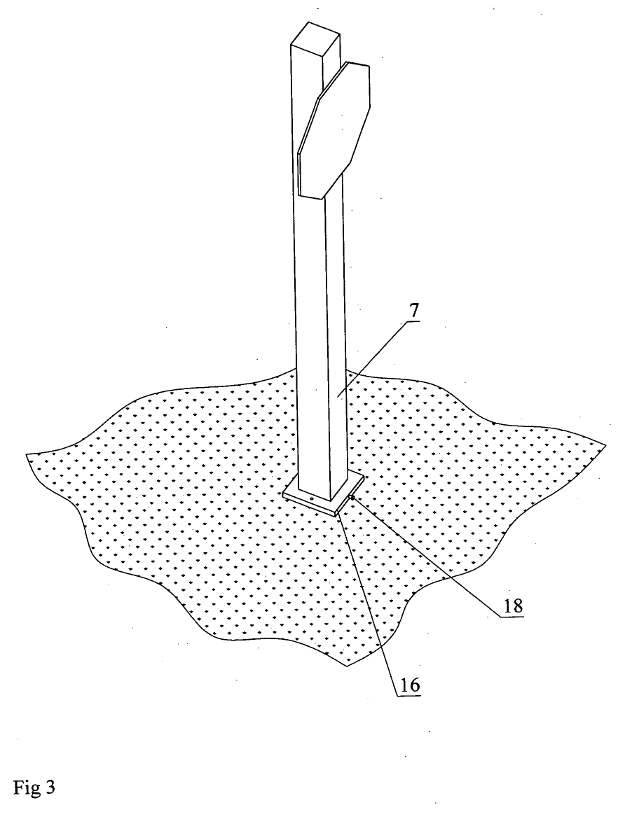

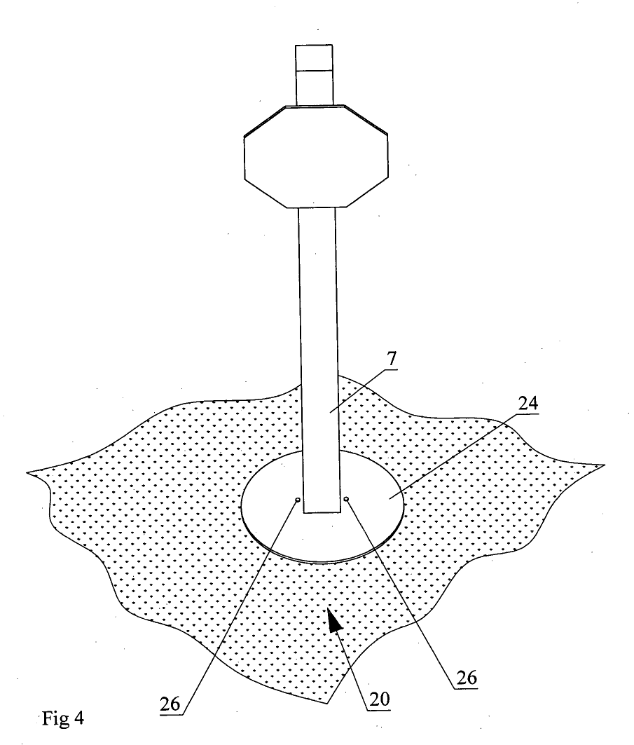

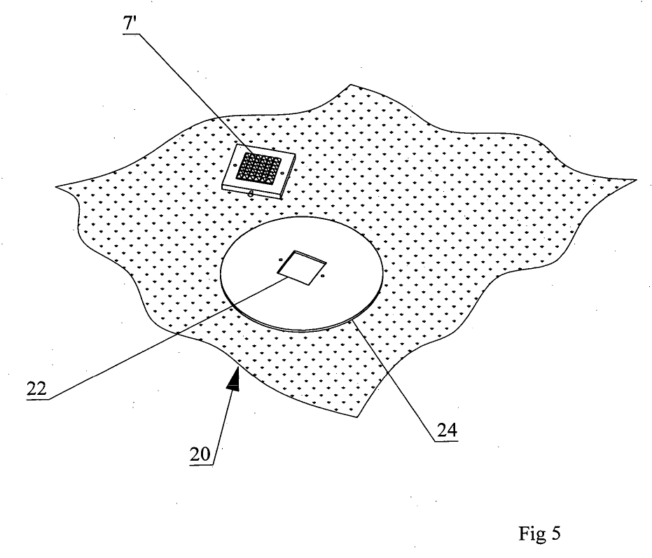

### DETAILED DESCRIPTION OF EMBODIMENTS OF THE INVENTION

With reference to the Figures wherein similar characters of reference denote corresponding parts in each view, the post support according to the present invention includes a hollow post-receiving member or sleeve 10 and a collar 20 detachably mounted to sleeve 10.

Sleeve 10 is sized to snugly receive journalled therein a post 7 such that a lower portion of post 7 may be removeably inserted in receiving member 10. In an embodiment of the invention, sleeve 10 is an elongate vertically extending sleeve defining a central bore. Sleeve 10 includes an open end 12 and a closed end 14 wherein post 7 may be inserted through open end 12 and received into the central bore. Preferably, the central bore is sized to snugly and securely receive post 7, and may be shaped to conform to the cross-sectional shape of the post. In an embodiment of the invention, closed end 14 may include a retaining means such as a barb 9 or for example a spike (not shown) wherein the base of post 7 may be impaled on the retaining means to secure post 7 within sleeve 10. Sleeve 10 may be cylindrical or generally rectangular in shape to receive post 7, a pole, or any other similar support structures.

Sleeve 10 may be installed below ground level in asphalt, concrete, earth, or any other type of terrain such that sleeve 10 is wholly or at least mostly or substantially disposed underground. Preferably, sleeve 10 extends five feet in length below ground level, although sleeve 10 for example may extend between two to eight feet in length underground, depending on the type of terrain, the weight and overall length of the post, etc such that sleeve 10 securely anchors post 7 in the ground. In an embodiment of the invention, closed end 14 may include at least two exterior flanges 15 to assist in retaining sleeve 10 in the ground. Sleeve 10 may be made of any conventional structural material including lightweight synthetic material to protect post 7 from environmental damage such that the structural integrity of post 7 may be preserved. For example, sleeve 10 may be made of plastic thereby preventing water or any other corrosive substances in the terrain from penetrating post 7, causing post 7 to rot or rust.

In an embodiment of the invention, a rim 16 is formed around open end 12, defining open end 12. Rim 16 may engage the surface of the ground when sleeve 10 is installed underground. A first securing means such as a screw or a bolt 18 or other conventional releasably securable fastener detachably engages and thereby secures post 7 within sleeve 10 when post 7 is disposed within sleeve 10. Although illustrated to be in rim 16, the first securing means may be mounted anywhere on sleeve 10 so long as it is accessible to a workman when the sleeve is installed in the ground to assist in authorized withdrawal of post 7 from sleeve 10, so long as the first securing means may be covered by collar 20. As illustrated, bolt 18 journals through a bore in rim 16 and penetrates into post 7. Thus with the collar removed, bolt 18 may be accessible from above ground level. For example, authorized personnel may need to remove the first securing means in order to withdraw a damaged post 7′ from sleeve 10 if post 7′ is broken off at the base for example or otherwise damaged and requires replacement or repair. In an embodiment of the invention, first securing means 18 includes a security feature such as a lock or the like to retain the collar as a cover over the first securing means, wherein only authorized personnel may unlock and remove the collar 20 to gain access to the first securing means. This deters prohibited removal of post 7 from sleeve 10.

Collar 20 defines a central aperture 22 such that post 7 journals through aperture 22 when collar 20 is detachably mounted to sleeve 10. Preferably, the dimensions of central aperture 22 corresponds with the dimensions of open end 12 of sleeve 10 such that post 7 snugly journals through central aperture 22 of collar 20. In an embodiment of the invention, collar 20 is annular and includes a flange 24 extending horizontally and radially outwards. When collar 20 is mounted on sleeve 10 and sleeve 10 installed in the ground, flange 24 rests on the surface of the ground and may serve to protect post 7 from elemental damage by preventing the ingress into sleeve 10 of rain, snow, or other elements that may cause structural damage to post 7. Preferably, but not necessarily, collar 20 may be made of the same lightweight synthetic material as sleeve 10.

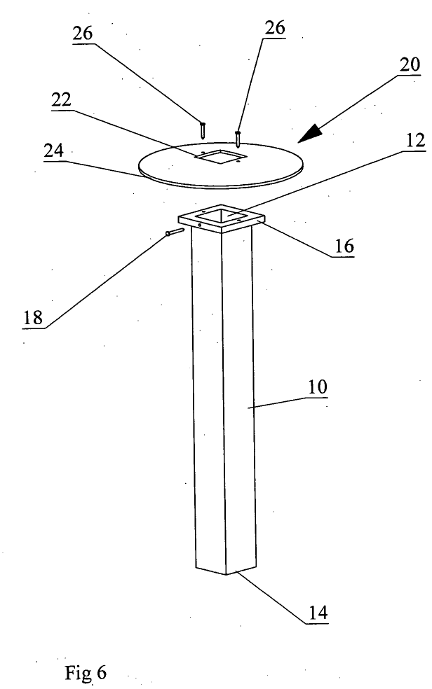

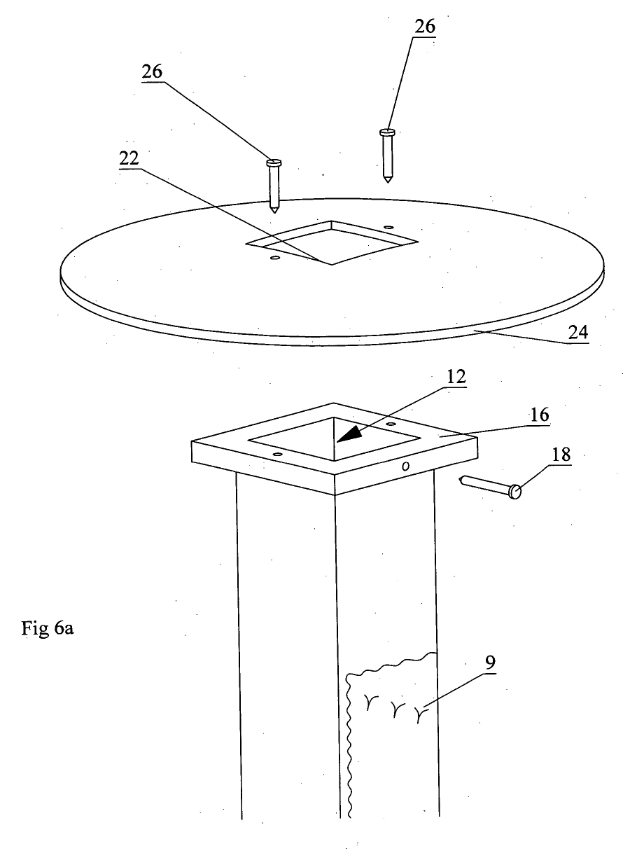

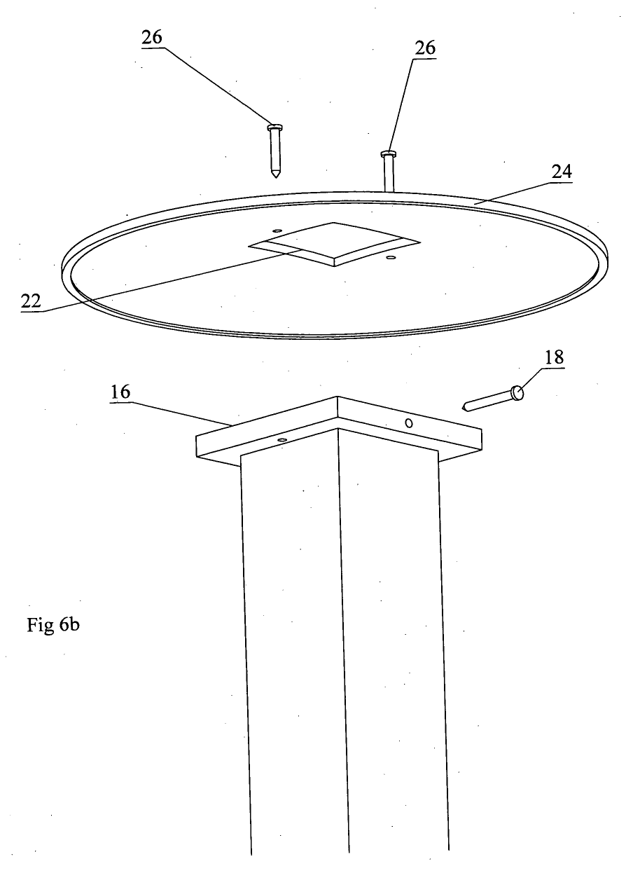

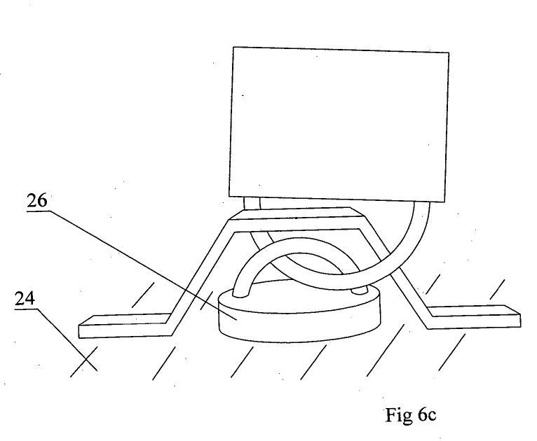

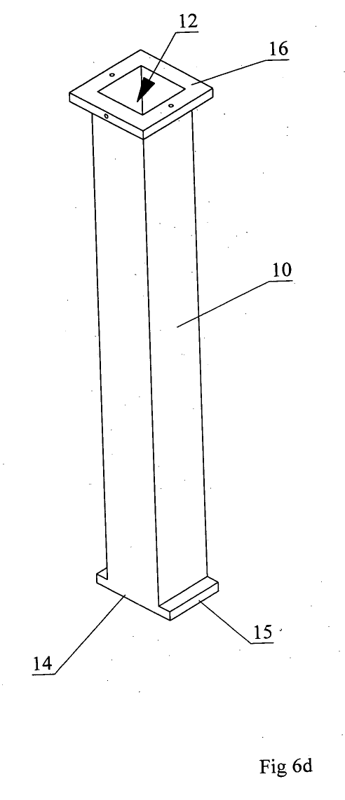

Collar 20 is detachably secured to sleeve 10 such that collar 20 and the first securing means cooperate to retain post 7 within sleeve 10. Collar 20 may be detachably mounted to sleeve 10 by a second securing means such as a screw or a bolt 26 or other conventional fastener including a selectively lockable fastener. The second securing means and collar 20 cooperate to inhibit and deter, and in the locking embodiment prevent, unauthorized access to the first securing means such that post 7 may be retained within sleeve 10. In particular, second securing means 26 may include a security feature such as a lock as seen in FIG. 6c whereby only authorized personnel may remove the second securing means 26. Preferably, second securing means 26 detachably secures collar 20 to rim 16 such that second securing means 26 may be accessible above ground level by authorized personnel. For example, if authorized personnel needed to withdraw post 7 or perform other maintenance work, collar 20 may be removed by detaching second securing means so that the first securing means may be accessed for removal of post 7 from sleeve 10.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

That is claimed is:

1. A post support comprising:
a receiving member configured to removably receive a post, said receiving member installed below ground level such that said receiving member is substantially disposed underground;
a collar defining an aperture, said collar detachably mounted to said receiving member such that said post journals through said aperture; and
a first securing means detachably securing said post to said receiving member when said post is inserted in said receiving member, said first securing means and said collar cooperating to retain said post within said receiving member.

2. The post support of claim 1 wherein said receiving member is an elongate vertically extending sleeve having an open end and a closed end, said sleeve defining a central bore configured to snugly and securely receive said post.

3. The post support of claim 2 wherein said receiving member forms a rim around said open end, said rim defining said open end wherein said post may be removably inserted into said central bore, said rim engaging a surface above ground level.

4. The post support of claim 3 wherein a second securing means detachably secures said collar to said rim, said second securing means accessible above ground level such that said collar may be removed so that said first securing means may be detached to remove said post from said receiving member.

5. The post support of claim 4 wherein said first securing means detachably secures said post to said rim, said first securing means accessible above ground level such that said first securing means may be detached to withdraw said post from said receiving member.

6. The post support of claim 5 wherein said collar is annular, said collar having a flange extending horizontally and radially outwards such that said flange engages said surface above ground level.

7. The post support of claim 6 wherein said flange secured to said rim prevents access to said first securing means such that impermissible withdrawal of said post from said receiving member may be deterred.

8. The post support of claim 7 wherein said receiving member and said collar are made of a synthetic material capable of protecting said post from environmental damage such that structural integrity of said post may be preserved.

9. The post support of claim 8 wherein said receiving member extends between two and eight feet in length below ground level when installed.

10. The post support of claim 9 wherein said first securing means and said second securing means includes a security feature to prevent unauthorized removal of said first and second securing means.

11. A post support comprising:
an elongate vertically extending sleeve having an open end and a closed end, said sleeve defining a central bore configured to snugly and securely removably receive a post, said sleeve installed below ground level such that said sleeve is substantially disposed underground;
an annular collar having a flange extending horizontally and radially outwards such that said flange engages a surface above ground level, said annular collar detachably mounted to said sleeve such that said post journals through an aperture defined by said annular;
a first securing means for detachably securing said post to said sleeve when said post is inserted in said sleeve; and
a second securing means for detachably securing said annular collar to said sleeve, said first securing means and said second securing means cooperating to retain said post within said sleeve.

12. The post support of claim 11 wherein said sleeve forms a rim around said open end, said rim defining said open end wherein said post may be removably inserted into said central bore, said rim engaging said surface above ground level.

13. The post support of claim 12 wherein said second securing means detachably secures said collar to said rim, said second securing means accessible above ground level such that said collar may be removed so that said first securing means may be detached to remove said post from said sleeve.

14. The post support of claim 13 wherein said first securing means detachably secures said post to said rim, said first securing means accessible above ground level such that said first securing means may be detached to withdraw said post from said sleeve.

15. The post support of claim 14 wherein said flange secured to said rim prevents access to said first securing means such that impermissible withdrawal of said post from said sleeve may be deterred.

16. The post support of claim 15 wherein said flange prevents ingress of fluid into said sleeve.

17. The post support of claim 16 wherein said sleeve and said collar are made of a synthetic material capable of protecting said post from environmental damage such that structural integrity of said post may be preserved.

18. The post support of claim 17 wherein said sleeve extends between two and eight feet in length below ground level when installed.

19. The post support of claim 18 wherein said first securing means and said second securing means includes a security feature to prevent unauthorized removal of said first and second securing means.

20. The post support of claim 19 wherein said closed end of said sleeve includes a retaining means configured to engage said post such that said post may be secured to said sleeve.
